(19) United States
(12) Patent Application Publication
(10) Pub. No.: US 2004/0024073 A1
(43) Pub. Date: Feb. 5, 2004

(54) Closure for bottle-like containers and method for production thereof

(76) Inventors: Ulrich Stieler, Goslar (DE); Werner Barlog, Engelskirchen (DE)

Correspondence Address: SALTER & MICHAELSON, THE HERITAGE BUILDING, 321 SOUTH MAIN STREET, PROVIDENCE, RI, 029037128

(21) Appl. No.: 10/221,897

(22) PCT Filed: Mar. 15, 2001
(86) PCT No.: PCT/EP01/02929

(30) Foreign Application Priority Data
Mar. 15, 2000 (DE) 100 12 394.5

(51) Int. Cl. C08J 9/00

(52) U.S. Cl. 521/51

(57) ABSTRACT

The invention relates to a method for the production of a cork-like closure for bottle-like containers, by means of a physical blowing agent and said cork-like closures obtained by said method.

A closure member for bottle-like containers, and a method for the manufacture thereof

The present invention relates to a method for the manufacture of a closure member for bottle-like containers by means of an injection moulding process or an extrusion process, and also to a closure member resulting from this process.

Traditional closure members for bottle-like containers such as wine or sparkling wine bottles are corks which are obtained from the bark of cork trees.

However, such naturally obtained cork cannot cover the drastically increased need for closure members of this type.

Thus, the cork tree is only grown in limited areas and it only grows slowly so that cork can only be obtained therefrom after 25 years. Cork becomes unusable for closure members due to the effects of micro-organisms, fertilisers etc. The evil-smelling substances lead to a so-called “corked taste” in the case of 5% to 10% of the wine bottles. As a result, approximately 800 million bottles of wine become undrinkable worldwide.

Consequently, high grade and perfect quality closure members made of natural cork are comparatively expensive, and as a result, high quality corks are reserved for high quality and hence expensive wines or sparkling wines.

However, for products of lesser quality, there is a need for an economical and taste-neutral alternative to the traditional cork closure members.

Thus rotary closure members made of metal have been used for wine and corks made of synthetic material that are profiled polyethylene stoppers have been used for sparkling wines, although these have only been accepted to a limited extent by consumers and the stigma of cheap products clings thereto.

Consequently, attempts have been made to find an alternative which emulates the natural cork in so far as possible in terms of appearance and usage such as, for example, in filling plants and when opening them with the aid of corkscrews.

Thus, a synthetic cork has been proposed which was manufactured from selected cork components and a polyurethane binder with the help of a chemical foaming agent (Expancel, a brand produced by the firm Akzo Nobel in France).

It has also been proposed that chemically foamed ethylene vinyl acetate be used as a replacement material for cork since this does not secrete any odorous materials or materials that can be tasted (sold by Novembal under the brand name “Tage”).

In the case of the chemical foaming agents employed here, these are compounds which are added to the material that is to be foamed and which expand due to chemical reactions resulting in the decomposition thereof and the release of gaseous materials so as to foam the surrounding material. In order to ignite the chemical foaming agent, the smelt must be raised to a suitable initial temperature for the foaming process which is often above the temperature that is required or ideal for processing the smelt. Due to the necessarily high temperature, there is not only an increase in the energy requirements but it may also prevent optimal processing from being achieved.

Another disadvantage is that the decomposition products and the residues of the chemical foaming agents are frequently not nature-identical and consequently, insofar as they remain in the foamed material, they are undesirable on foodstuff grounds since they are not taste-neutral for example, or are even questionable for health reasons. In addition, unfired foaming agents remaining in chemically foamed articles prevent recycling of the foamed article since the remaining foaming agent could ignite in an uncontrolled manner during the processing or recycling thereof so that it is not possible to obtain a reproducible recycling process.

From a processing point of view, it is a disadvantage that the heat of reaction is released during the decomposition of the chemical foaming agent, this thereby contributing to the heating of the surrounding material so that cycles of longer duration will be required for cooling and solidifying the material. In addition, a chemically foamed article must be kept in the mould for a longer period of time in order to prevent an undesirable foam overblow, i.e. a so-called after swelling, due to the high temperatures ensuing.

Known stoppers of synthetic material also exhibit an unsatisfactory sealing effect.

One reason for this is that these corks consist of very hard and non-pliable or scarcely pliable materials which cannot be compressed when inserted into the neck of a bottle in a similar manner to a natural cork which is pressed closely against the inner walls of the neck of the bottle due to the pressure exerted on the inner walls by virtue of the compression, this thereby ensuring that the closure member will be leak-proof.

In order to solve this problem, it was proposed in DE 198 49 149 A1 that stoppers of synthetic material for bottles and the like should be prepared from a plastic foam and that the foam be of an open-celled nature at the sealing surfaces but be of a closed-cell nature elsewhere. It was intended hereby, that an adequate seal between the sealing surfaces and the inner wall of the neck of the bottle would be achieved by virtue of the open-celled structure since the edges of the cells functioned like sealing lips. Polypropylene was mentioned here as being an example of a suitable material.

Consequently, the object of the present invention was to provide a substitute for natural cork closure members, and also to provide a method by which a substitute cork of this type can be manufactured in a simple manner whilst avoiding the problems mentioned hereinabove.

This object is achieved by a method of manufacturing a closure member for bottle-like containers wherein the closure member is obtained by foaming a foamable material, which is selected from a thermoplastic elastomer and a renewable, preferably a biologically degradable raw material, by means of a physical foaming agent.

An injection moulding process or an extrusion process is utilised as a suitable manufacturing process.

In accordance with the invention, the foaming process is effected by means of a physical foaming agent. The foaming effect produced by physical foaming agents is based upon the expansion of the material employed as a result of a change in the aggregate state thereof, for example, from a fluid to a gaseous form or the expansion of a compressed gas when the pressure is released.

For the purposes of the method in accordance with the invention, fluids that do not form any dubious residues are employed as the physical foaming agent. Hereby, we are preferably concerned with compounds that are nature-identical such as, for example, carbon dioxide, nitrogen or water. These foaming agents can be added to the material requiring foaming whilst they are in a compressed state and will then expand during the foaming process due to the reduced pressure and/or the increased temperature prevailing in the smelt during the foaming process.

Physical foaming agents usually diffuse out entirely from the resultant product during the foaming process or during the cooling process occurring thereafter and they do not leave any residues behind. In so far as small quantities of residues do remain, these are not critical due to the nature-identical nature of the foaming agent.

In comparison with the employment of chemical foaming agents, the employment of physical foaming agents in accordance with the invention also has the advantage that one thereby obtains a closed-pore product having an impervious closed-pore outer skin and closed pores in the interior, something which cannot be obtained in the case of conventional chemical foaming processes without further action.

In addition, the employment of physical foaming agents has the advantage that the smelt can be processed at its ideal temperature and, unlike the case of chemical foaming agents, an activating temperature does not have to be defined which is such that it will initiate the decomposition of the chemical foaming agent and which is usually higher than the requisite smelt temperature.

Moreover, the expansion or the change in the aggregate state of the physical foaming agent extracts heat from the surroundings so that more rapid cooling and hence shorter cycle times can be obtained or, in the case of extrusion, higher withdrawal speeds (more metres or more articles per unit of time) can be obtained. Over-blowing or after-swelling such as occurs with chemical foaming agents does not take place.

In order for the closure member to form an adequate seal, it is necessary for it to rest firmly and closely on the inner wall of the neck of the bottle. In order to ensure such adequately tight sealing engagement, the material of the closure member should not be too hard so that it will then be capable of being compressed somewhat when inserted into the neck of the bottle. The pressure exerted by such compression leads to a leak-proof closure arrangement.

Consequently, in accordance with the invention, a foamable material having a certain amount of elasticity, such as thermoplastic elastomers of petrochemical origin, is used as the material for the closure member.

The method of foaming using physical foaming agents in accordance with the invention is also particularly suitable for replaceable raw materials whereby biologically degradable raw materials are preferred. For reason of better sealing properties, the hardness of this raw material should only be such as to correspond to that of the thermoplastic elastomers.

Examples of thermoplastic elastomers are copolyesters, polyether esters, polyether block amides, polyurethane (TPU), thermoplastic poly-blends of polypropylene and ethylene propylene terpolymer or nitrile rubbers, styrene block copolymers, such as styrene ethylene/butylene styrene for example, styrene ethylene/propylene styrene and styrene butadene styrene, ethylene vinyl acetate polymers and also blends based upon the aforesaid material groups where SEBS (styrene ethylene/butylene styrene block copolymer) is particularly preferred. Polymers based upon silicon could also be employed.

Examples of renewable and preferably biological degradable materials are starch esters and cellulose based polymers.

Suitable degrees of hardness for achieving adequate sealing properties preferably lie in the range of Shore A 65 to A 90. By contrast, polypropylene as is used in DE 198 49 149 A1 for example has a hardness of Shore D>60.

In accordance with the invention, conventional injection moulding processes or extrusion processes could be utilised such as are frequently used for differing purposes and which are also known for chemical foaming processes.

For example, extrusion of the closure members in accordance with the invention using physical foaming agents can be effected in analogous manner to the extrusion of sealing elements as has been utilised already in the construction of automobiles using thermoplastic elastomers and water as a physical foaming medium.

An injection moulding process is preferably employed for the manufacture of closure members for higher value products since the surfaces of injection moulded articles are usually of better quality in regard to the ability thereof to form a closed-pore structure than correspondingly obtained articles using an extrusion technique.

It is particularly preferred that the closure member have a non-foamed outer skin and a foamed core.

Hereby, a first partial smelt without foaming agent is initially added to the mould and thereafter a second part comprising a foaming agent is added thereto. If necessary, a third part without foaming agent could then be added. Methods of manufacturing injection moulded articles having a non-foamed skin and a foamed core are known and could be utilised for the purposes of the invention. An example of such a method is described in the international patent application WO 00/54952.

The physically foamed cork-like closure member in accordance with the invention can be used advantageously as a substitute for natural corks for wine, sparkling wine and spirits or as stoppers.

1. A method of manufacturing a closure member for bottle-like containers,
characterised in that
the closure member is obtained by foaming a foamable starting material selected from a thermoplastic elastomer and a renewable raw material, wherein a physical foaming agent is utilised for the foaming process.

2. A method in accordance with claim 1,
characterised in that
an injection moulding process or an extrusion process is utilised for the manufacturing process.

3. A method in accordance with claim 1 or 2,
characterised in that
the physical foaming agent is a fluid.

4. A foamed closure member for bottle-like containers obtained
in accordance with any of the preceding Claims, characterised in that
the foamed material has a closed-pore structure.

5. A foamed closure member in accordance with claim 4,
characterised in that
the closure member has a non-foamed outer skin and a foamed closed-pore core.

6. The use of a closure member obtained in accordance with any of the claims 1 to 4 as corks or stoppers for bottles.
